(19) United States
(12) Patent Application Publication
(10) Pub. No.: US 2006/0243810 A1
(43) Pub. Date: Nov. 2, 2006

(54) ASSEMBLY FOR SECURING A POWER SUPPLY AND CABLE CONNECTED THERETO

(76) Inventors: James E. Clark JR., Cedar Lake, IN (US); Jason E. Duncan, Peoria, IL (US)

Correspondence Address: HARTMAN & HARTMAN, P.C., 552 EAST 700 NORTH, VALPARAISO, IN, 46383, US

(21) Appl. No.: 11/381,188

(22) Filed: May 2, 2006

Related U.S. Application Data
(60) Provisional application No. 60/594,724, filed on May 2, 2005.

(51) Int. Cl. G06K 19/06

(52) U.S. Cl. 235/492

(57) ABSTRACT

An assembly and method capable of preventing power interruption from a power supply that provides power through a cable to electrical equipment. The assembly includes first and second members, each having a base and a first extension projecting therefrom to define a recess. At least one of the first extensions has a channel defined therein in communication with the recess of its member. The assembly further includes features for orienting and securing the first and second members together such that their recesses cooperate to define a continuous interior cavity surrounded by the first and second members and the channel defines a continuous passage interconnected with the interior cavity. The interior cavity is sized and shaped to secure a power supply within the first and second members, and the passage between the first extensions is sized and shaped to secure a power cable to the power supply.

### CROSS REFERENCE TO RELATED APPLICATIONS

This application claims the benefit of U.S. Provisional Application No. 60/594,724, filed May 2, 2005, the contents of which are incorporated herein by reference.

### BACKGROUND OF THE INVENTION

The present invention generally relates to power supplies and power supply connections. More particularly, this invention relates to an assembly for securing power supply connections to a power supply, as well as securing the power supply in a manner that promotes the reliability of power supplied by the power supply to electronic equipment, such as transaction terminals used in point of sale (POS) applications.

POS terminals are widely used in retail sales applications that benefit from the capability of an electronic sales transaction. An example of such a POS system is commercially available from VeriFone under the name RUBY. Retail gasoline sales are an example of a POS application, in which a POS terminal located on the counter of a gasoline station communicates with pump islands to record the gasoline sale and print a receipt to the purchaser. The POS terminal and its various peripheral components are powered by a power supply that provides the proper voltage (typically DC) and current levels to the terminal and its peripherals. An example of such a power supply is the Model UP10515010 unit commercially available from VeriFone.

Because the software and hardware of POS systems are often sensitive to power interruptions, POS power supplies often draw power from a backup power system that will continue to provide power to the power supply for a period sufficient to enable the attendant to complete any transactions that were pending at the moment power loss occurred. However, the power cable connecting the power supply to the POS hardware is vulnerable to being disconnected, and POS power units are often stored in locations where overheating and cable disconnection due to physical instability of the supply are possible. In the event of a sudden power loss, POS systems can “crash,” causing data loss and potential damage to the POS system hardware.

In view of the above, it would be desirable if an apparatus were available that reduced if not eliminated the risk of power interruption from power units that supply power through a cable to equipment that are sensitive to power interruptions.

### BRIEF SUMMARY OF THE INVENTION

The present invention provides an assembly and method capable of preventing power interruption from a power supply that provides power through a cable to electrical equipment, and particularly equipment such as POS systems that are sensitive to power interruptions.

The assembly of this invention includes first and second members, each of which has a base and at least a first extension projecting from the base so that the base and first extension cooperate to define a recess in their respective first and second members. The first extension of at least one of the members has a channel defined therein in communication with the recess of its member. The assembly further includes features for orienting and securing the first and second members together such that their recesses cooperate to define a continuous interior cavity surrounded by the first and second members and the channel defines a continuous passage between the first extensions and interconnected with the interior cavity. According to a preferred aspect of the invention, the interior cavity of the assembly is sized and shaped to secure a power supply within and surrounded by the first and second members, and the passage between the first extensions is sized and shaped to secure a power cable to the power supply.

The method of this invention generally entails providing an assembly comprising first and second members, each comprising a base and at least a first extension projecting from the base so that the base and first extension cooperate to define a recess, with at least one of the first extensions having a channel defined therein in communication with its corresponding recess. The first and second members are then oriented and secured together such that their recesses cooperate to define a continuous interior cavity in which a cross-sectional portion of the power supply is received and surrounded by the first and second members and the channel defines a continuous passage between the first extensions and in which the power cable of the power supply is received and secured to the power supply.

In view of the above, it can be seen that a significant advantage of this invention is that an uncomplicated assembly is provided that can be quickly installed to secure a cable to a power supply, thereby preventing unintentional power interruptions that would result from disconnection of the cable. In applications where power interruptions can crash an electronic system, such as hardware of a POS system, the assembly prevents data loss and damage to the system. As a result, the assembly of this invention can avoid the extended downtime associated with such crashes, as well as prevent the loss of revenue and avoid the cost of a service call to restart the system.

Other objects and advantages of this invention will be better appreciated from the following detailed description.

### BRIEF DESCRIPTION OF THE DRAWINGS

FIG. 1 is a perspective view showing an assembly in accordance with a preferred embodiment of this invention.

FIG. 2 is a cross-sectional view showing a power supply and its cable secured by and within the assembly of FIG. 1.

FIGS. 3, 4, and 5 are interior, side, and end views, respectively, of a first member of the assembly of FIGS. 1 and 2.

FIGS. 6 and 7 are interior and side views, respectively, of a second member of the assembly of FIGS. 1 and 2.

### DETAILED DESCRIPTION OF THE INVENTION

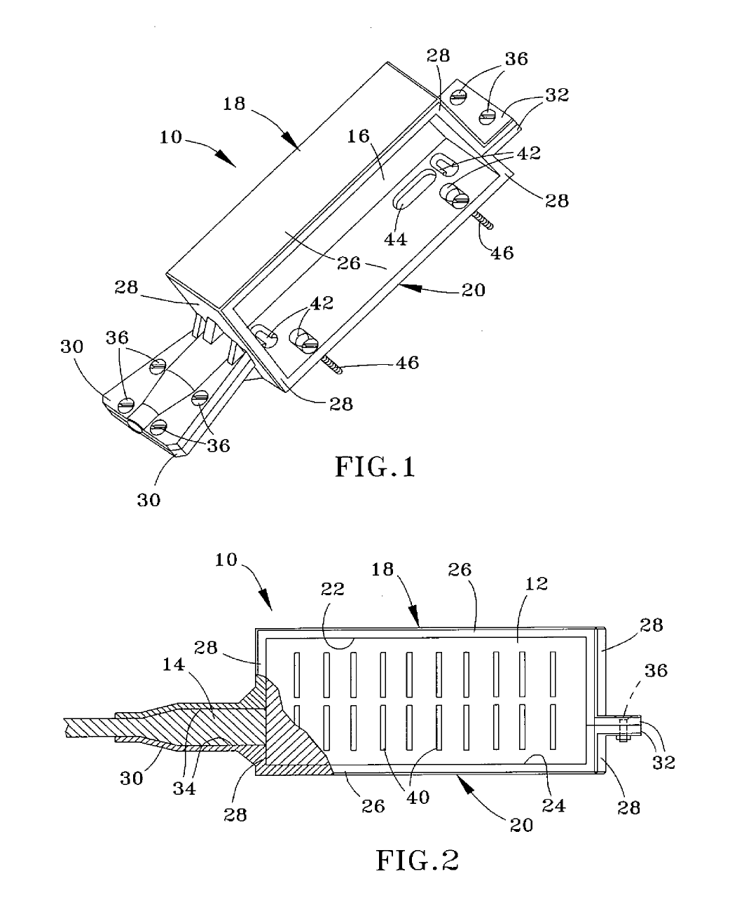

FIGS. 1 and 2 represent an assembly 10 adapted to secure a power supply 12 and secure a power cable 14 to the power supply 12. The assembly 10 can be configured to secure a wide variety of power supplies and their cables, though the assembly 10 is particularly intended for use with power supplies used in POS systems.

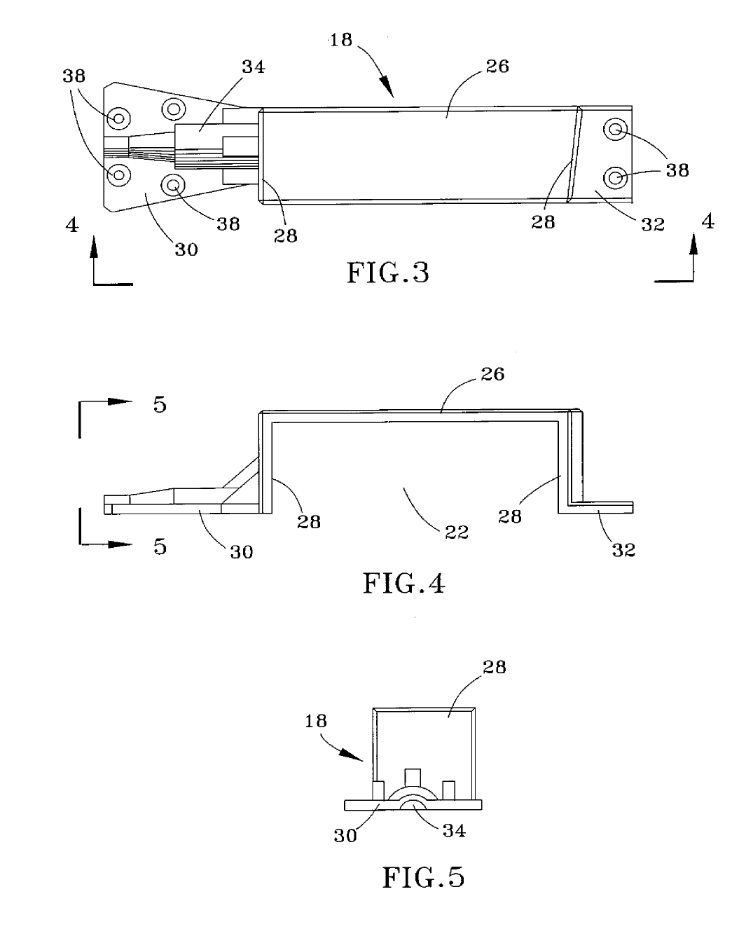

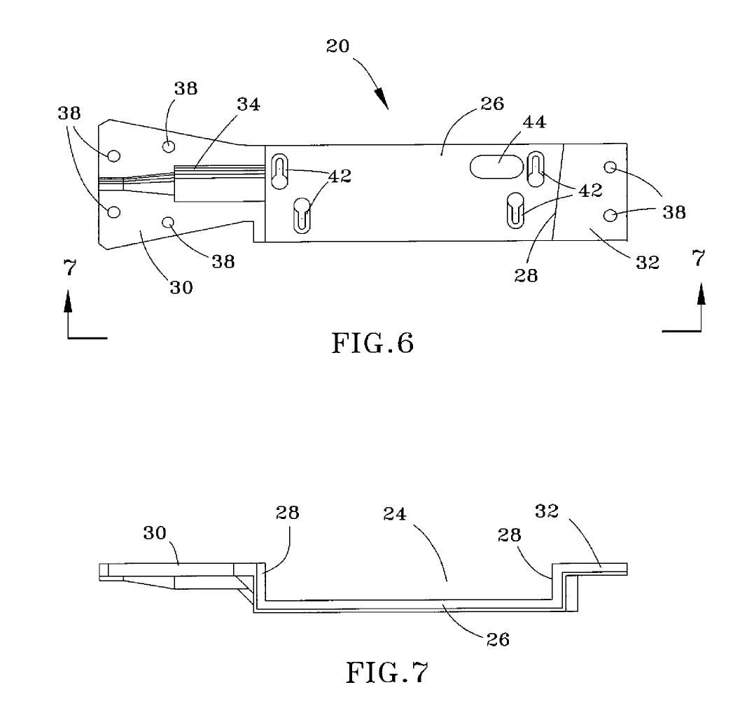

As evident from FIGS. 1 and 2, the assembly 10 is composed of two members 18 and 20, which for convenience will be referred to herein as the upper and lower members 18 and 20, though this nomenclature is not meant to indicate a required orientation for the assembly 10. Suitable materials for the member 18 and 20 include polypropylene, which is strong, lightweight, and nonconductive, though a wide variety of others would also be suitable for the members 18 and 20. As evident from the more detailed views of the FIGS. 3 through 7, the members 18 and 20 are approximately mirror images of each other, with each defining a recess 22 and 24, except that the recess 22 of the upper member 18 is deeper than the recess 24 of the lower member 20. When the members 18 and 20 are mated as shown in FIGS. 1 and 2, the recesses 22 and 24 combine to form an interior cavity 16 through and surrounded by the assembly 10, within which the power supply 12 is received and held by the members 18 and 20.

Each member 18 and 20 generally includes a base portion 26, extensions 28 at opposite ends of the base portion 26 and approximately perpendicular to the base portion 26, and flanges 30 and 32 extending from the extensions 28 approximately parallel to the base portion 26. One set of flanges 30 is significantly larger than the other 32, with each flange 30 defining a channel 34 that, when the flanges 30 are mated as shown in FIGS. 1 and 2, define a continuous passage through which the power cable 14 extends. The channels 34 have tapered portions so as to grip the cable 14 and prevent its disconnection from the power supply 12. While a stepped tapered cross-section is depicted in the Figures, it should be readily evident that other cross-sectional shapes capable of gripping a cable are also within the scope of this invention.

The members 18 and 20 are shown as being held together with fasteners 36 received in complementary holes 38 formed in the flanges 30 and 32. The recesses 22 and 24 and the channels 34 formed in the members 18 and 20 are sized and shaped to ensure that, under the clamping load of the fasteners 36, the power supply 12 and its cable 14 are clamped and held firmly by the assembly 10. As such, the flanges 30 and 32, fasteners 36, and fastener holes 38 cooperate to orient the members 18 and 20 relative to each other and as well as secure the members 18 and 20 together.

As evident from FIGS. 1 and 2, the cavity 16 within the assembly 10 has a generally rectangular cross-sectional shape corresponding to that of the power supply 12. However, from FIGS. 3 through 7, the extension 28 adjacent the smaller flange 32 of each member 18 and 20 is oriented so as not to be parallel to the extension 28 adjacent the larger flange 30, with the result that the wall of the assembly 10 defined by this extension 28 tapers from side-to-side through the cavity 16 defined by the recesses 22 and 24. In other words, the cross-section of the cavity 16 is not constant through the assembly 10. This shape is configured to mate with certain power supplies 12, such as the Model UP10515010 unit commercially available from VeriFone. However, it should be evident that such a shape may not be required to be compatible with other power supplies. The extensions 28 of the members 18 and 20 also differ in that the extensions 28 of the upper member 18 are longer than those of the lower member 20, such that the recess 22 of the upper member 18 is larger or deeper than the recess 24 of the lower member 20. This difference is primarily due to the need for the passage defined by the channels 34 to be offset from the center of the power supply 12 in order to be aligned with the cable 14, as evident from FIG. 2.

As seen in FIG. 2, the power supply 12 has vents 40 through which heat can be dissipated from the supply 12. The assembly 10 does not cover these vents 40, but instead is assembled onto the power supply 12 so that its vents 40 are well outside the assembly 10. For example, the widths of the members 18 and 20 may be one-quarter to one-third of the corresponding width of the power supply 12 so that the majority of the power supply 12 protrudes outside the assembly cavity 16. To ensure that the power supply 12 will efficiently dissipate heat in its operating environment, the lower member 20 of the assembly 10 is preferably equipped with mounting holes 42 in its base portion 26 that enable the assembly 10 to mount the power supply 12 to a surface, such as a vertical wall or partition, with fasteners 46. In this manner, the assembly 10 can be used to mount the power supply 12 to not only protect its cable 14, but also orient and support the power supply 12 to ensure that ventilation around and through the supply 12 is not hampered by surrounding obstacles and equipment. Finally, an oblong recess 44 is shown as being formed in the interior surface of the base portion 26 of the lower member 20. The oblong recess 44 is sized and located to receive a pad or pedestal (not shown) often present on the lower surface of the power supply 12. In this manner, the pad/pedestal and oblong recess 44 cooperate to help lock the power supply 12 within the assembly 10.

While the invention has been described in terms of a preferred embodiment, it is apparent that other forms could be adopted by one skilled in the art. For example, the physical configuration of the assembly 10 and its members 18 and 20 could differ from that shown, materials other than those noted could be used, and various other techniques could be used to secure the members 18 and 20 together. Therefore, the scope of the invention is to be limited only by the following claims.

1. An assembly for securing a power cable connected to a power supply, the assembly comprising:
a first member comprising a base and at least a first extension projecting from the base so that the base and the first extension cooperate to define a recess in the first member;
a second member comprising a base and at least a first extension projecting from the base so that the base and first extension cooperate to define a recess in the second member;
a channel in at least one of the first extensions of the first and second members; and
means for orienting and securing the first and second members together such that the recesses of the first and second members cooperate to define a continuous interior cavity surrounded by the first and second members and the channel defines a continuous passage between the first extensions and interconnected with the interior cavity.

2. The assembly according to claim 1, wherein the orienting and securing means comprise flanges on each of the first extensions of the first and second members.

3. The assembly according to claim 2, wherein the orienting and securing means further comprise fasteners securing together the flanges of the first extensions of the first and second members.

4. The assembly according to claim 2, wherein the channel is defined in at least one of the flanges of the first extensions.

5. The assembly according to claim 1, wherein the interior cavity surrounded by the first and second members has a substantially rectangular cross-section.

6. The assembly according to claim 1, wherein the interior cavity surrounded by the first and second members has a nonconstant, tapering cross-section.

7. The assembly according to claim 1, further comprising a power supply secured within the interior cavity and surrounded by the first and second members, and a power cable connected to the power supply and secured thereto by the continuous passage between the first extensions.

8. The assembly according to claim 1, wherein the passage has a nonconstant cross-sectional area.

9. The assembly according to claim 1, wherein each of the first and second members further comprises a second extension, and the recesses of the first and second members are defined by the bases and the first and second extensions thereof.

10. The assembly according to claim 9, wherein the first and second extensions of the first member are longer than the first and second extensions of the second member such that the recess of the first member is larger than the recess of the second member.

11. The assembly according to claim 1, further comprising means defined in the second member for mounting the assembly to a vertical surface.

12. An assembly secured to a power supply so as to secure a power cable to the power supply, the assembly comprising:
a first member comprising a base and first and second extensions projecting from the base so that the base and first and second extensions cooperate to define a recess in the first member, the first extension having a channel defined therein in communication with the recess of the first member;
a second member comprising a base and first and second extensions projecting from the base so that the base and first and second extensions cooperate to define a recess in the second member, the first extension of the second member having a channel defined therein in communication with the recess of the second member; and
means for orienting and securing the first and second members together such that the recesses of the first and second members cooperate to define a continuous interior cavity in which a cross-sectional portion of the power supply is received and surrounded by the first and second members and the channels of the first extensions of the first and second members cooperate to define a continuous passage between the first extensions and in which the power cable of the power supply is received and secured to the power supply.

13. The assembly according to claim 12, wherein the orienting and securing means comprise:
flanges on each of the first and second extensions of the first and second members; and
fasteners securing together the flanges of the first extensions of the first and second members and fasteners securing together the flanges of the second extensions of the first and second members, the channels of the first extensions being defined in the flanges of the first extensions.

14. The assembly according to claim 12, wherein the interior cavity surrounded by the first and second members has a nonconstant, tapering cross-section.

15. The assembly according to claim 12, wherein the passage has a nonconstant cross-sectional area.

16. The assembly according to claim 12, wherein the first and second extensions of the first member are longer than the first and second extensions of the second member such that the recess of the first member is larger than the recess of the second member, the assembly further comprising means defined in the second member for mounting the assembly with the power supply therein to a vertical surface.

17. The assembly according to claim 16, wherein the mounting means comprises holes through the base of the second member.

18. A method of securing a power cable to a power supply, the method comprising the steps of:
providing an assembly comprising first and second members, each of the first and second members comprising a base and at least a first extension projecting from the base so that the base and the first extension cooperate to define a recess, at least one of the first extensions of the first and second members having a channel defined therein; and
orienting and securing the first and second members together such that the recesses of the first and second members cooperate to define a continuous interior cavity in which a cross-sectional portion of the power supply is received and surrounded by the first and second members and the channel defines a continuous passage between the first extensions and in which the power cable of the power supply is received and secured to the power supply.

19. The method according to claim 18, wherein the first and second members are formed such that the first extension of the first member is longer than the first extension of the second member and the recess of the first member is larger than the recess of the second member.

20. The method according to claim 18, further comprising the step of mounting the assembly with the power supply therein to a vertical surface.
